(19) United States
(12) Patent Application Publication
(10) Pub. No.: US 2013/0182097 A1
(43) Pub. Date: Jul. 18, 2013

(54) METHOD OF IMAGING A LONGITUDINAL CONDUIT

(71) Applicants: Régis Lasnel, Pau (FR); Erwann Houzay, Pau (FR); Noomane Keskes, Pau (FR)

(72) Inventors: Régis Lasnel, Pau (FR); Erwann Houzay, Pau (FR); Noomane Keskes, Pau (FR)

(73) Assignee: TOTAL SA, Courbevoie (FR)

(21) Appl. No.: 13/877,314

(22) PCT Filed: Sep. 27, 2011
(86) PCT No.: PCT/FR2011/052256

§ 371 Date: Apr. 1, 2013

(30) Foreign Application Priority Data
Oct. 1, 2010 (FR) 1057986

(51) Int. Cl. H04N 5/225

(52) U.S. Cl. CPC H04N 5/225
USPC 348/81

(57) ABSTRACT

The invention relates to a method of imaging a longitudinal conduit resting by its base on the seabed, comprising the following steps: acquiring a set of images of at least a part of the conduit by a mobile underwater acquisition device, each image being associated with a temporal reference corresponding to the moment of its acquisition, extracting from each image the zone included in one and the same window, said window being predefined with respect to the frame of the images, and effecting an unwrapped image of at least a part of the conduit by juxtaposing, in chronological order, the extracted zones of each image.

### RELATED APPLICATIONS

The present application is a National Phase entry of PCT Application No. PCT/FR2011/052256, filed Sep. 27, 2011, which claims priority from FR Application No. 1057986 filed Oct. 1, 2010, both of which are hereby incorporated by reference herein in their entirety.

### FIELD OF THE INVENTION

The invention relates to a method for inspecting conduits on the seabed and more particularly a method for detecting unsupported spans under such conduits.

### BACKGROUND OF THE INVENTION

Detection of unsupported spans beneath underwater conduits, for example oil pipelines, is of considerable importance. The unsupported spans represent areas of weakness for such structures because additional mechanical stresses are applied to unsupported spans. These areas must therefore be regularly identified and filled in to minimize the risks of breakage or leaks in the structure.

Inspection of underwater conduits, particularly detection of unsupported spans, is currently done using exploratory robots filming the conduit from the outside. Said robot moves laterally along the conduit, maintaining a relatively constant orientation and viewing angle relative to the axis of the conduit. In prior art methods, the videos are stored in embedded memory and retrieved at the end of the survey, as the video files are too large to be sent to the surface in real time. These videos are then viewed in their entirety by an operator. Detection of unsupported spans beneath underwater conduits is therefore a tedious and highly time-consuming process.

### SUMMARY OF THE INVENTION

An object of the invention is to propose an imaging method which allows exhaustively observing a longitudinal conduit resting by its base on the seabed, without having to view long video sequences. A second object of the invention is to propose a method for detecting unsupported spans beneath underwater conduits, using an imaging method of the invention.

A first aspect of the invention proposes a method for imaging a longitudinal conduit resting by its base on the seabed, said method comprising:
capturing a set of images of at least a portion of the conduit to be observed, by means of a mobile underwater acquisition device, said device being moved along the conduit at a substantially constant distance relative to the longitudinal axis of said conduit and maintaining, during the movement of said acquisition device, a substantially constant angle between the viewing axis of said acquisition device and the longitudinal axis of the conduit, each image being associated with a temporal reference corresponding to the moment of its capture,
extracting from each image the region contained within one and the same window, said window being predefined relative to the frame of the images,
creating a scrolled image of at least a portion of the conduit by juxtaposing, in chronological order, the regions extracted from each image.

Advantageously, the method of the invention enables rapid and economical observation of the longitudinal conduit, by means of the scrolled image of the conduit. The file corresponding to the scrolled image is much smaller than the set of files corresponding to the images of the conduit captured during the acquisition step. This facilitates the transmission and processing of information concerning the conduit.

In other embodiments, an imaging method according to the invention can comprise the following characteristics, singularly or in combination:
the acquisition device is sensitive to the visible wavelengths;
the mobile underwater acquisition device illuminates the conduit in a manner such that the lighting is coaxial to the viewing axis of the acquisition device;
the spatiotemporally scrolled image is saved as a grayscale image;
the acquisition device is moved along the conduit at a substantially constant speed.

One aspect of the invention also concerns a method for detecting unsupported spans under a longitudinal conduit resting by its base on the seabed, said method comprising the imaging steps according to the invention in which the portion to be observed of the longitudinal conduit comprises at least the base of the conduit and the seabed on which it rests, the method additionally comprising a thresholding step during which the detection of unsupported spans is achieved by means of radiometric thresholding making use of the difference in brightness between the unsupported spans and the areas where the base of the conduit rests on the seabed.

Advantageously, the method of the invention allows determining the unsupported spans in a less tedious manner than with prior art methods, and does so more economically.

In various embodiments, the method for detecting unsupported spans according to the invention can comprise:
a trimming step during which the spatiotemporally scrolled image is trimmed by eliminating the area corresponding to the conduit in order to retain only the area corresponding to the seabed; and/or
the temporal position of the unsupported spans, identified in the spatiotemporally scrolled image, is converted into a spatial position using the temporal references for the images of the conduit captured by the acquisition device.

### BRIEF DESCRIPTION OF THE DRAWINGS

Other features, aims, and advantages of the invention will be apparent from reading the detailed description of one of its embodiments. The invention will also be better understood by referring to the drawings, in which:

FIG. 1 schematically illustrates the path and the orientation of the mobile underwater acquisition device relative to the conduit;

FIG. 2 illustrates an example of a choice of accumulation window;

FIG. 3 illustrates the principle of converting a sequence of images into a two-dimensional scrolled image;

FIG. 4 shows an example of a scrolled image obtained by an imaging method of the invention;

FIG. 5 illustrates the step of trimming the scrolled image of a conduit in the context of detection of unsupported spans;

FIG. 6A illustrates the detection of unsupported spans by radiometric thresholding.

FIG. 6B illustrating FIG. 6A with threshold level adjusted for sharpness.

### DESCRIPTION OF EMBODIMENTS

In the sense of the invention, the “longitudinal axis” of the longitudinal conduit is understood to mean the line which passes through the center of all transverse cross-sections of said conduit.

A first aspect of the invention concerns an imaging method which allows obtaining a spatiotemporally scrolled image of an underwater conduit, for example an oil pipeline, a gas pipeline, or a conduit for water or telecommunications cables (electrical or optical fiber). In one embodiment of the invention, the imaging method can comprise:
an acquisition step during which a set of images of at least a portion of a conduit resting by its base on the seabed is captured,
an extraction step during which a region contained within one and the same window predefined relative to the frame of the images is extracted from each image,
a scrolling step during which a scrolled image of at least a portion of the conduit is obtained.

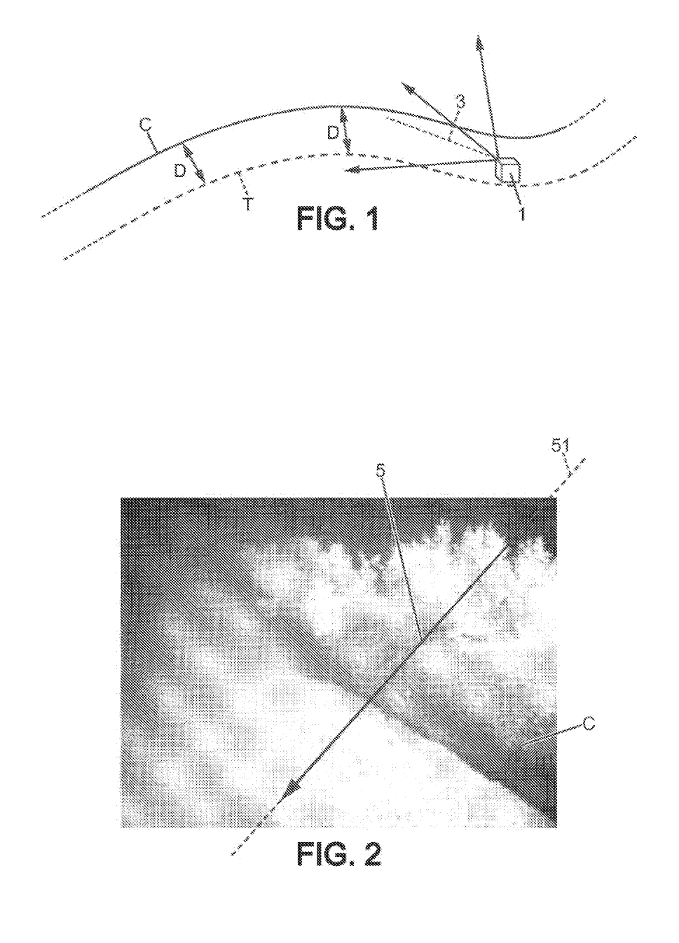

In one embodiment of the invention, the acquisition step is conducted by means of a mobile underwater acquisition device 1, for example a submersible robot of the type well known in the prior art for inspecting underwater oil pipelines. Said device is moved along the conduit C following a path T, as illustrated in FIG. 1.

The path T is determined such that the acquisition device moves outside the conduit C at a substantially constant distance D along said path T and the acquisition device can be moved along said path T while maintaining a substantially constant angle between the viewing axis 3 of the acquisition device 1 and the longitudinal axis of the conduit C.

In one embodiment of the invention, the acquisition device 1 is moved along the path T at a substantially constant speed.

Each image captured during the acquisition step is associated with a temporal reference corresponding to the instant moment of its capture.

In one embodiment of the invention, the acquisition device can be a video camera sensitive to the visible wavelengths and recording sequences of images at a rate of between 15 and 30 images per second.

In one embodiment, the duration of an acquisition sequence is set by an operator or by a computer program. For example, the duration of an acquisition sequence is such that the acquisition covers the entire conduit. In one embodiment, shorter sequences only covering a portion of the conduit can be obtained. In this manner, one can advantageously choose to film only a portion of the conduit.

The video sequences captured during the acquisition step are then converted into scrolled images during the extraction and scrolling steps.

Before the extraction step, the method of the invention can comprise a definition step during which a window 5 is defined relative to the frame of the images captured during the acquisition step. In one embodiment, the window 5 is substantially rectangular in shape. In the embodiment in FIG. 2, this window 5 is a rectangle whose position on the image is defined relative to the frame of the image. The window 5 can have a width of one pixel. In different embodiments of the invention, the width of the window 5 can be greater than one pixel, for example two or three pixels.

The width of the window can be determined as a function of the speed at which the acquisition device is moving along the path T and the acquisition speed of said acquisition device.

In one embodiment, the window 5 has a rectangular shape in which the longitudinal axis 51 is chosen to be perpendicular to the longitudinal axis of the conduit C as it appears in the images, such as the image in FIG. 2 for example. In one embodiment of the invention, the determination of the rectangular accumulation window 5 can be done by a computer program.

During the extraction step, each image is processed so that the region contained within the window 5 predefined relative to the frame of the images is extracted from each image. Each extracted region is associated with the temporal reference for the image from which said region is extracted.

During the scrolling step, a scrolled image of the conduit is created by juxtaposing the regions 7 extracted from each image in the acquisition sequence. The extracted regions 7 are placed side by side in chronological order. In one embodiment, the image obtained by juxtaposing the regions 7 is saved as a grayscale image. An image saved as a grayscale image is advantageously smaller than a color image.

In one embodiment of the invention, the steps of extraction and scrolling can be simultaneous. For example, the extraction and juxtapositions are performed with each advancement, image by image.

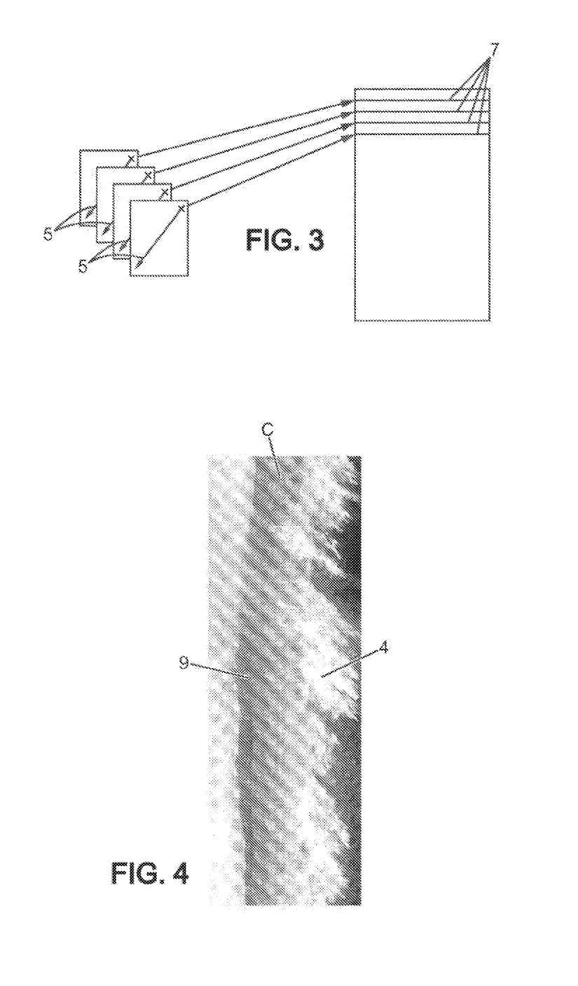

The principle of constructing the scrolled image is illustrated in FIG. 3 for the case shown in FIG. 2 where the window 5 is rectangular and has a thickness of one pixel. For each image, the region contained 7 within the window 5 is extracted and constitutes a row of the scrolled image. Each row of pixels is associated with a temporal reference corresponding to the time at which the image from which the row is extracted was taken.

The elements such as an unsupported span 9 or seaweed 4 which may be observed in such a spatiotemporally scrolled image, of which an example is given in FIG. 4, are thus identified by a “temporal position”.

The invention also relates to a method for detecting unsupported spans under a longitudinal conduit C resting by its base on the seabed, using an imaging method of the invention. To be able to detect unsupported spans using this method, it is preferable that said unsupported spans 9 be visible in the scrolled images of the longitudinal conduit. It is therefore preferable if the acquisition field of the acquisition device comprises the base of the conduit C and the seabed on which it rests.

The detection of unsupported spans 9 is then conducted on the scrolled image of the conduit C. FIG. 4 shows an example of a scrolled image of a portion of conduit in which an unsupported span 9 can be seen. In one embodiment, the detection of unsupported spans can additionally comprise a thresholding step during which the unsupported spans are identified in the scrolled image of the longitudinal conduit.

In one embodiment of the invention, in order to detect unsupported spans, the thresholding step makes use of the difference in brightness, in the scrolled images, between the unsupported spans 9 and the areas where the base of the conduit C is properly in contact with the seabed.

Locating unsupported spans is done using radiometric thresholding. In one embodiment, the radiometric thresholding is conducted using image processing software, for example THE GIMP or Photoshop. The use of thresholding will indicate areas in which the brightness is less than a threshold value in black, and areas in which the brightness is greater than said threshold value in black.

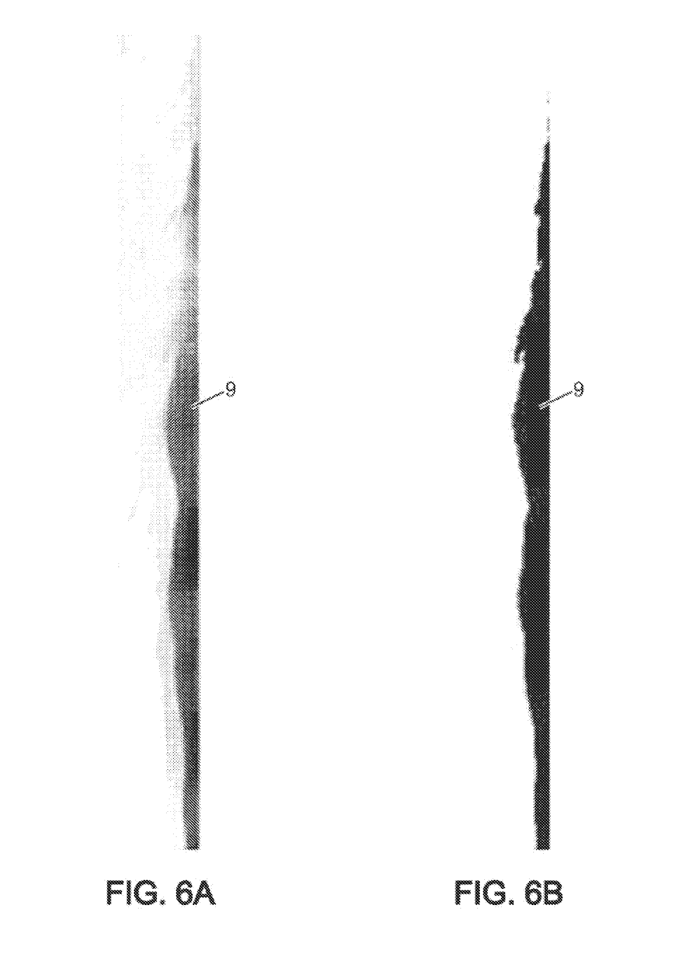

The areas appearing in black on the image are likely to be unsupported spans. This advantageously facilitates the detection of unsupported spans 9, because a blank image is obtained in which the potential unsupported spans appear in black, as illustrated in FIGS. 6A and 6B. Advantageously, the level of the threshold can be adapted to the desired sharpness in the identification of unsupported spans [See FIG. 6b]. In one embodiment, the threshold level is adjusted by computer means.

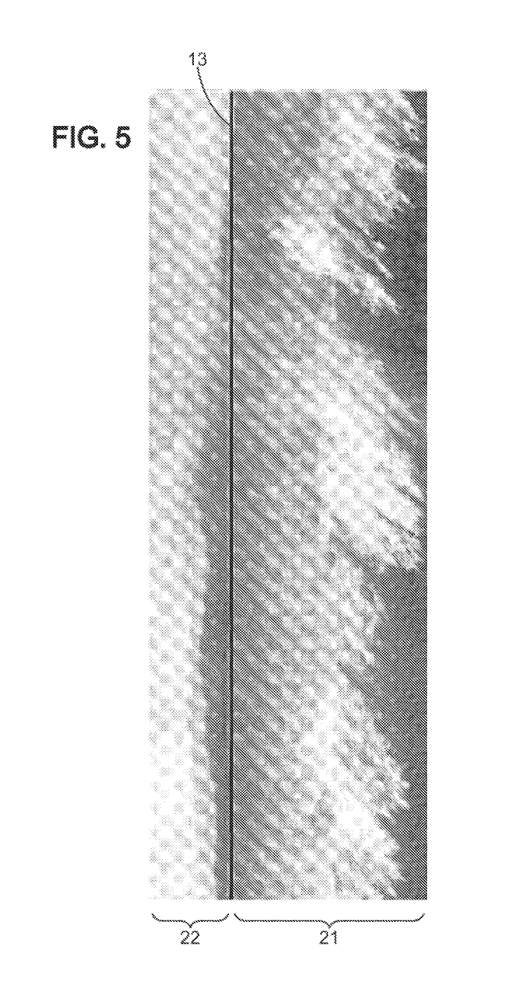

In one embodiment of the invention, the method for detecting unsupported spans can comprise a trimming step during which the portion corresponding to the conduit in the spatiotemporally scrolled images is eliminated in order to retain only the portion of the image corresponding to the seabed. This step is illustrated in FIG. 5. The boundary 13 separates the area 21 corresponding to the image of the conduit and the area 22 corresponding to the seabed. The boundary 13 corresponds to the base of the longitudinal conduit.

Only the area 22 corresponding to the portion of the image containing the seabed is retained. Advantageously, this step reduces the amount of data to be stored or processed during the method and facilitates the detection of unsupported spans 9 by retaining only the portion of the image in which unsupported spans may be found. In one embodiment, the determination of the row 13 where the image is cut is done by computer means.

As indicated above, in the scrolled image each extracted region is associated with a temporal reference. The unsupported spans detected in the scrolled image are therefore detected by a “temporal position” and have a “duration” during which they are present in the scrolled image. In the method of the invention, the “temporal position” is converted into a “spatial position”, which allows determining the position of the unsupported spans. The “duration” allows determining the size of the unsupported spans.

To perform this conversion, it is preferable to know the path T of the acquisition device 1 while it is capturing the sequence of images used to create the scrolled image in which one or more unsupported spans were identified. Knowing the path T of the device 1 as a function of time, and the “temporal position” of an unsupported span, it is possible to determine the spatial position of said unsupported span.

Advantageously, a method for detecting unsupported spans according to the invention accelerates and simplifies the detection of said areas. Instead of analyzing long video sequences, one analyzes two-dimensional images. In addition, a method according to the invention reduces the amount of data to be analyzed and the analysis time, such that the detection of unsupported spans can be done simultaneously with the step in which the mobile underwater acquisition device captures sequences of images of the conduit.

The invention is not limited to the embodiments described, and is not be interpreted in a limiting manner; it encompasses any equivalent embodiment. In particular, the conversion of sequences of images into scrolled images and one or more analysis steps can be done by computer means in the mobile underwater acquisition device. The transmission of data collected by the acquisition device simultaneously with the acquisition of the sequence of images is possible, allowing detection of unsupported spans in real time.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1-8. (canceled)

9. A method for imaging a longitudinal conduit resting by a base thereof on the seabed, said method comprising:
capturing a set of images of at least a portion of the conduit to be observed, by means of a mobile underwater acquisition device, said device being moved along the conduit at a substantially constant distance relative to a longitudinal axis of said conduit and maintaining, during the movement of said acquisition device, a substantially constant angle between a viewing axis of said acquisition device and the longitudinal axis of the conduit, each image being associated with a temporal reference corresponding to a capture instant;
extracting from each image a region contained within a common same window, said window being predefined relative to a frame of the images; and
creating a scrolled image of at least a portion of the conduit by juxtaposing, in chronological order, the regions extracted from each image.

10. The imaging method of claim 9, wherein the acquisition device is sensitive to visible wavelengths.

11. The imaging method of claim 10, wherein the mobile underwater acquisition device illuminates the conduit in a manner such that lighting is coaxial to the viewing axis of the acquisition device.

12. The imaging method of claim 9, wherein the spatiotemporally scrolled image is saved as a grayscale image.

13. The imaging method of claim 9, wherein the acquisition device is moved along the conduit at a substantially constant speed.

14. A detection method for detecting unsupported spans under a longitudinal conduit resting by a base thereof on the seabed, said detection method comprising:
capturing a set of images of at least a portion of the conduit to be observed, by means of a mobile underwater acquisition device, said device being moved along the conduit at a substantially constant distance relative to a longitudinal axis of said conduit and maintaining, during the movement of said acquisition device, a substantially constant angle between a viewing axis of said acquisition device and the longitudinal axis of the conduit, each image being associated with a temporal reference corresponding to a capture instant, wherein the portion to be observed of the longitudinal conduit comprises at least the base of the conduit and the seabed on which it rests;
extracting from each image a region contained within a common same window, said window being predefined relative to a frame of the images;
creating a scrolled image of at least a portion of the conduit by juxtaposing, in chronological order, the regions extracted from each image; and
detecting unsupported spans in a thresholding step by means of radiometric thresholding making use of a difference in brightness between the unsupported spans and areas where the base of the conduit rests on the seabed.

15. The detection method of claim 14, further comprising a trimming step in which the spatiotemporally scrolled image is trimmed by eliminating an area corresponding to the conduit in order to retain only an area corresponding to the seabed.

16. The detection method of claim 14, wherein a temporal position of the unsupported spans, identified in the spatiotemporally scrolled image, is converted into a spatial position using the temporal references for the images of the conduit captured by the acquisition device.
